(19) United States
(12) Patent Application Publication
(10) Pub. No.: US 2024/0119714 A1
(43) Pub. Date: Apr. 11, 2024

(54) IMAGE RECOGNITION MODEL TRAINING METHOD AND APPARATUS

(71) Applicant: Alipay (Hangzhou) Information Technology Co., Ltd., Hangzhou (CN)

(72) Inventors: Yinggui WANG, Hangzhou (CN); Li WANG, Hangzhou (CN); Lei WANG, Hangzhou (CN)

(21) Appl. No.: 18/478,852

(22) Filed: Sep. 29, 2023

(30) Foreign Application Priority Data
Sep. 30, 2022 (CN) CN202211215646.2

(51) Int. Cl. G06V 10/80; G06V 10/771

(52) U.S. Cl. CPC G06V 10/80; G06V 10/771

(57) ABSTRACT

Implementations of the present specification provide an image recognition model training method and apparatus. Each first member device performs data desensitization processing on training sample image data based on frequency domain transform to obtain first desensitized image data; provides the first desensitized image data to a hyperparameter selection model to select a first hyperparameter; performs image mixing processing on the first desensitized image data based on data augmentation by using the first hyperparameter to obtain second desensitized image data and second label data that is label mixing processed and corresponding to the second desensitized image data; and then trains an image recognition model by using the second desensitized image data and the second label data. A second member device updates the image recognition model by using a model training result received from each first member device.

### TECHNICAL FIELD

Implementations of the present specification generally relate to the field of artificial intelligence technologies, and in particular, to an image data processing method and apparatus, an image recognition model training method and apparatus, and an image recognition method and apparatus.

### BACKGROUND

A service processing solution based on an image recognition model is widely used in a large number of applications, for example, a face-scanning payment service based on a facial recognition model. Image data related to data privacy information (for example, user privacy information) is usually distributed in different data owners or different regions and countries. To protect the data privacy information, data sharing of the private data is not allowed between data owners or between different regions. However, to provide a user with a better service by using sufficient data, information between data needs to be adequately mined for a specific task to train an image recognition model. Therefore, a federated learning method is proposed. In the method, private image data of a plurality of data owners can be used to train an image recognition model while the data does not leave a domain.

### SUMMARY

Inventors recognized that in the federated learning method, after locally completing image recognition model training, each data owner needs to share gradient information or weight information with a model owner for aggregation, which causes information leakage of the gradient information or the weight information. Techniques of this specification avoid reconstructing original image data from shared gradient information or weight information.

Implementations of the present specification provide an image recognition model training method and apparatus. Through the image recognition model training method and apparatus, data desensitization processing is performed on image data based on frequency domain transform to obtain desensitized image data, and image mixing processing is performed on the obtained desensitized image data based on data augmentation. Subsequently, an image recognition model is locally trained by using the desensitized image data that is image mixing processed, and a model updating amount of the locally trained image recognition model is shared with a model owner, to avoid reconstructing original image data from the shared model updating amount, thereby protecting data privacy of the original image data.

According to an aspect of the implementations of the present specification, an image recognition model training method is provided. The method is performed by a first member device having local training data, and the method includes iteratively performing a model training process until a model training end condition is satisfied, where the model training processing includes: obtaining current training sample image data and label data of the current training sample image data; performing data desensitization processing on the current training sample image data based on frequency domain transform to obtain first desensitized image data of the current training sample image data; providing the first desensitized image data to a hyperparameter selection model to select, from a candidate hyperparameter set, a first hyperparameter used to indicate a number of images participating in image mixing processing; performing image mixing processing on the first desensitized image data based on Mixup data augmentation by using the first hyperparameter to obtain second desensitized image data and second label data that is label mixing processed and corresponding to the second desensitized image data; training a current image recognition model by using the second desensitized image data and the second label data; and providing a model training result of the current image recognition model to a second member device configured to maintain an image recognition model, for the second member device to update the image recognition model by using model training results from a plurality of first member devices including the first member device; and receiving an updated image recognition model from the second member device, so as to use the updated image recognition model for a next round of image recognition model training.

In some implementations, in an example of the above aspect, before the providing the first desensitized image data to the hyperparameter selection model to select, from the candidate hyperparameter set, the first hyperparameter used to indicate the number of images participating in image mixing processing, the method can further include: in response to that a first predetermined threshold is satisfied, updating the hyperparameter selection model by using a model updating process, including: providing the first desensitized image data to the hyperparameter selection model to select, from the candidate hyperparameter set, a second hyperparameter used to indicate the number of images participating in image mixing processing; performing image mixing processing on the first desensitized image data based on data augmentation by using the second hyperparameter to obtain third desensitized image data and third label data that is label mixing processed and corresponding to the third desensitized image data; providing the third desensitized image data to the current image recognition model to obtain second predicted label data of the third desensitized image data, and determining a first loss function based on the second predicted label data and the third label data; updating the current image recognition model based on the first loss function; providing the third desensitized image data to the updated current image recognition model to obtain third predicted label data of the third desensitized image data, and determining a second loss function based on the third predicted label data and the third label data; determining a third loss function based on the first loss function and the second loss function; and updating a model parameter of the hyperparameter selection model based on the third loss function.

In some implementations, in an example of the above aspect, the first predetermined threshold can include: a round interval between a current number of training rounds of the image recognition model and a number of training rounds at a time of a previous update processing of the hyperparameter selection model reaches a first threshold number of rounds.

In some implementations, in an example of the above aspect, the providing the model training result of the current image recognition model to the second member device can include: providing the model training result of the current image recognition model to the second member device in response to that a second predetermined threshold is satisfied.

In some implementations, in an example of the above aspect, the second predetermined threshold can include: a round interval between a current number of training rounds of the image recognition model and a number of training rounds of the image recognition model when a previous training result was sent reaches a second threshold number of rounds.

In some implementations, in an example of the above aspect, the first hyperparameter is k, and a maximum weight coefficient of a mixed image is Wₘₐₓ. The performing image mixing processing on the first desensitized image data based on data augmentation by using the first hyperparameter can include: performing (k−1) times of scrambling processing on an image data set of the first desensitized image data to obtain k image data sets; constructing an image hypermatrix with a size of m*k based on the k image data sets, where a first column in the image hypermatrix corresponds to the image data set of the first desensitized image data in an original form before the scrambling processing, and m is an amount of image data in the original image data set; randomly generating a weight coefficient for each piece of image data in the image hypermatrix; normalizing the weight coefficients of the image data in the image hypermatrix, so that a sum of weight coefficients of each row of image data is 1, and the weight coefficient of each piece of image data is not greater than W max ; and performing weighted summation on each row of image data in the image hypermatrix to obtain a mixed image hypermatrix with a size of m*1, where the image data in the mixed image hypermatrix is desensitized image data that is data augmentation processed.

In some implementations, in an example of the above aspect, the performing data desensitization processing on the current training sample image data based on frequency domain transform can include: performing local frequency domain transform processing on the current training sample image data to obtain at least one feature graph, where each feature graph of the at least one feature graph includes a plurality of elements and corresponds to a data block in the current training sample image data, and each element corresponds to a frequency in a frequency domain; respectively constructing, by using elements corresponding to frequencies in the at least one feature graph, frequency component channel feature graphs corresponding to the frequencies; and selecting at least one target frequency component channel feature graph from the constructed frequency component channel feature graphs to obtain desensitized image data of the current training sample image data, where the selected target frequency component channel feature graph includes a key channel feature for image recognition.

In some implementations, in an example of the above aspect, after the selecting the at least one target frequency component channel feature graph from the constructed frequency component channel feature graphs, the method can further include: performing a first shuffling processing on the target frequency component channel feature graph to obtain a first shuffled feature graph; and performing normalization processing on the first shuffled feature graph to obtain the first desensitized image data of the current training sample image data.

In some implementations, in an example of the above aspect, after the performing normalization processing on the first shuffled feature graph, the method can further include: performing channel mixing processing on the first shuffled feature graph that is normalization processed; performing a second shuffling processing on the first shuffled feature graph that is channel mixing processed, to obtain a second shuffled feature graph; and performing normalization processing on the second shuffled feature graph to obtain the first desensitized image data of the current training sample image data.

According to an aspect of the implementations of the present specification, an image recognition model training method is provided. The method is performed by at least two first member devices having local training data and a second member device configured to maintain an image recognition model, and the method includes iteratively performing a model training process until a model training end condition is satisfied, where the model training process includes: locally training, by each first member device of the at least two first member devices, a current image recognition model by using local training sample image data according to the method described above; and updating, by the second member device, the current image recognition model by using model training results of the current image recognition model received from the at least two first member devices, and sending an updated image recognition model to the at least two first member devices to perform local model training.

According to an aspect of the implementations of the present specification, an image recognition model training apparatus is provided. The apparatus is applied to a first member device having local training data, and the apparatus includes: an image recognition model receiving unit, configured to obtain a current image recognition model from a second member device configured to maintain an image recognition model; a training sample data acquisition unit, configured to obtain current training sample image data and label data of the current training sample image data; a data desensitization processing unit, configured to perform data desensitization processing on the current training sample image data based on frequency domain transform to obtain first desensitized image data of the current training sample image data; a hyperparameter selection unit, configured to provide the first desensitized image data to a hyperparameter selection model to select, from a candidate hyperparameter set, a first hyperparameter used to indicate a number of images participating in image mixing processing; an image mixing processing unit, configured to perform image mixing processing on the first desensitized image data based on Mixup data augmentation by using the first hyperparameter to obtain second desensitized image data and second label data that is label mixing processed and corresponding to the second desensitized image data; a model training unit, configured to train the current image recognition model by using the second desensitized image data and the second label data; and a model training result sending unit, configured to send a model training result of the current image recognition model to the second member device, for the second member device to update the current image recognition model by using the model training result, where the image recognition model receiving unit, the training sample data acquisition unit, the data desensitization processing unit, the hyperparameter selection unit, the image mixing processing unit, the model training unit, and the model training result sending unit iteratively perform operations until a model training end condition is satisfied.

In some implementations, in an example of the above aspect, the apparatus can further include: a hyperparameter selection model updating unit, configured to: in response to that a first predetermined threshold is satisfied, update the hyperparameter selection model by using a following model updating process, including: providing the first desensitized image data to the hyperparameter selection model to select, from the candidate hyperparameter set, a second hyperparameter used to indicate the number of images participating in image mixing processing; performing image mixing processing on the first desensitized image data based on data augmentation by using the second hyperparameter to obtain third desensitized image data and third label data that is label mixing processed and corresponding to the third desensitized image data; providing the third desensitized image data to the current image recognition model to obtain second predicted label data of the third desensitized image data, and determining a first loss function based on the second predicted label data and the third label data; updating the current image recognition model based on the first loss function; providing the third desensitized image data to the updated image recognition model to obtain third predicted label data of the third desensitized image data, and determining a second loss function based on the third predicted label data and the third label data; determining a third loss function based on the first loss function and the second loss function; and updating a model parameter of the hyperparameter selection model based on the third loss function.

According to another aspect of the implementations of the present specification, an image recognition model training system is provided, including: at least two first member devices, where each first member device has local training sample image data, and includes the image recognition model training apparatus described above; and a second member device, where the second member device maintains an image recognition model, and the second member device includes: a model training result receiving unit, configured to receive a model training result of an image recognition model from each first member device; a model updating unit, configured to update the current image recognition model by using the model training result of the current image recognition model received from each first member device; and a model sending unit, configured to send an updated image recognition model to each first member device to perform local model training.

According to another aspect of the implementations of the present specification, an image recognition model training apparatus is provided, including: at least one processor, a memory coupled to the at least one processor, and a computer program stored in the memory. The at least one processor executes the computer program to implement the image recognition model training method described above.

According to another aspect of the implementations of the present specification, an image recognition model training apparatus is provided, including: at least one processor, a memory coupled to the at least one processor, and a computer program stored in the memory. The at least one processor executes the computer program to implement the image recognition model training method described above.

According to another aspect of the implementations of the present specification, a computer-readable storage medium is provided. The computer-readable storage medium stores executable instructions, and when the executable instructions are executed, a processor is enabled to perform the image recognition model training method described above.

According to another aspect of the implementations of the present specification, a computer program product is provided, including a computer program. The computer program is executed by a processor to implement the image recognition model training method described above.

### BRIEF DESCRIPTION OF DRAWINGS

The features and advantages of the implementations in the present specification can be further understood by referring to the following accompanying drawings. In the accompanying drawings, similar components or features can have the same reference numerals.

FIG. 1 is an example schematic diagram illustrating a federated learning system for training an image recognition model according to an implementation of the present specification;

FIG. 2 is an example flowchart illustrating an image recognition model training method performed on a first member device side according to an implementation of the present specification;

FIG. 3 is an example flowchart illustrating a data desensitization processing process based on frequency domain transform according to an implementation of the present specification;

FIG. 4 is an example schematic diagram illustrating transform of image feature data from a spatial domain to a frequency domain according to an implementation of the present specification;

FIG. 5 is an example schematic diagram illustrating a local frequency domain transform process according to an implementation of the present specification;

FIG. 6 is an example schematic diagram illustrating a frequency component channel feature graph according to an implementation of the present specification;

FIG. 7 is another example flowchart illustrating a data desensitization processing process based on frequency domain transform according to an implementation of the present specification;

FIG. 8 is an example flowchart illustrating a process of updating a hyperparameter selection model according to an implementation of the present specification;

FIG. 9 is an example flowchart illustrating a hyperparameter selection process based on a hyperparameter selection model according to an implementation of the present specification;

FIG. 10 is an example flowchart illustrating an image mixing processing process based on data augmentation according to an implementation of the present specification;

FIG. 11 is an example diagram illustrating a structure of an image recognition model according to an implementation of the present specification;

FIG. 12 is an example block diagram illustrating an image recognition model training apparatus according to an implementation of the present specification;

FIG. 13 is an example block diagram illustrating a data desensitization processing unit according to an implementation of the present specification;

FIG. 14 is an example block diagram illustrating a data desensitization processing unit according to another implementation of the present specification;

FIG. 15 is an example block diagram illustrating an image mixing processing unit according to an implementation of the present specification;

FIG. 16 is an example block diagram illustrating a hyperparameter selection unit according to an implementation of the present specification;

FIG. 17 is an example block diagram illustrating a hyperparameter selection model updating unit according to an implementation of the present specification;

FIG. 18 is an example block diagram illustrating an image recognition model training apparatus of a second member device according to an implementation of the present specification; and

FIG. 19 is an example schematic diagram illustrating an image recognition model training apparatus that is implemented based on a computer system and that is applied to a first member device side according to an implementation of the present specification.

### DESCRIPTION OF EMBODIMENTS

The subject matter described in the present specification is now discussed with reference to example implementations. It should be understood that these implementations are merely discussed to enable a person skilled in the art to better understand and implement the subject matter described in the present specification, and are not intended to limit the protection scope, applicability, or examples described in the claims. Functions and arrangements of the discussed elements can be changed without departing from the protection scope of the content in the present specification. Based on a requirement, examples can be omitted or replaced, or various processes or components can be added. For example, the described method can be performed in an order different from the described order, and steps can be added, omitted, or combined. In addition, features described relative to some examples can also be combined in other examples.

As used in the present specification, the term “include” and variant thereof represent open terms, and mean “including but not limited to”. The term “based on” means “at least partially based on”. The terms “one implementation” and “an implementation” represent “at least one implementation”. The term “another implementation” represents “at least one other example”. The terms “first”, “second”, etc. can refer to different or same objects. The following can include other definitions, regardless of whether the definitions are explicit or implicit. Unless explicitly stated in the context, definitions of a term are consistent throughout the entire present specification. The term “predetermined” mean that a value, a parameter, a threshold, or a rule is determined before it is used in an relevant operation or processing. A “predetermined” value, parameter, threshold, or rule can be dynamically determined or adjusted by a machine automatically with or without human inputs. The term “predetermined” does not mean or limit that a value, a parameter, a threshold, or a rule is fixed or input in advance by a human.

A service processing solution based on an image recognition model is widely used in a large number of applications, for example, a face-scanning payment service based on a facial recognition model. Image data related to data privacy information (for example, user privacy information) is usually distributed in different data owners or different regions and countries. To protect the data privacy information, data sharing of the private data is not allowed between data owners or between different regions. However, to provide a user with a better service by using sufficient data, information between data may be adequately mined for a specific task to train an image recognition model.

Therefore, a federated learning method is proposed. In the method, private image data of a plurality of data owners can be used to train an image recognition model while the data does not leave a domain. However, in the federated learning method, after locally completing image recognition model training, each data owner may share gradient information or weight information with a model owner for aggregation, which causes information leakage of the gradient information or the weight information.

A federated learning solution based on mixed data desensitization is provided according to the implementations of the present specification. In the federated learning solution, when training an image recognition model by using local training sample image data, a first member device first performs data desensitization processing on the training sample image data based on frequency domain transform, then performs image mixing on desensitized image data by using an image mixing processing method based on, e.g., Mixup data augmentation, and subsequently trains the image recognition model by using the desensitized image data that is image mixing processed, thereby improving a data privacy protection capability in federated learning. In addition, during image recognition model training, a hyperparameter selection model is further used to adaptively select an appropriate image mixing parameter (e.g., a number of images participating in image mixing) based on first desensitized image data, so as to ensure not only that a plurality of pieces of desensitized image data can be fused in an image recognition model training process, but also that model training performance is not significantly affected.

The following describes an example image recognition model training method and an example apparatus according to the implementations of the present specification with reference to the accompanying drawings.

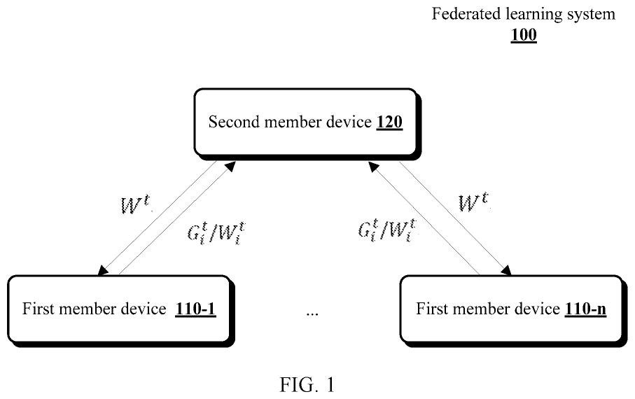

FIG. 1 is an example schematic diagram illustrating a federated learning system 100 for training an image recognition model according to an implementation of the present specification.

As shown in FIG. 1, the federated learning system 100 includes at least two first member devices 110-1 to 110-n and a second member device 120. The at least two first member devices 110-1 to 110-n can communicate with the second member device 120 through networks, for example, but not limited to, the Internet or a local area network. In some implementations, the network can be any one or more of a wired network or a wireless network. Examples of a network 330 can include but are not limited to a cable network, an optical fiber network, a telecommunications network, an intranet, the Internet, a local area network (LAN), a wide area network (WAN), a wireless local area network (WLAN), a metropolitan area network (MAN), a public switched telephone network (PSTN), a Bluetooth network, ZigBee network (ZigBee), near field communication (NFC), an in-device bus, an in-device line, or any combination thereof.

In this implementation of the present specification, the first member devices 110-1 to 110-n can be devices or device parties configured to locally collect image data samples, for example, intelligent terminal devices or server devices. In the present specification, the term “first member device” and the terms “data owner” and “client device” can be used interchangeably. The collected image data sample can be referred to as a local image data sample.

In the present specification, local image data samples of the first member devices 110-1 to 110-n jointly form training sample data of an image recognition model, and the local image data sample of each of the first member devices 110-1 to 110-n can be kept as a secret of the first member device, so that the local image data sample will not be learned or completely learned by another first member device or the second member device.

The second member device 120 can be a device or a group or cluster of devices configured to maintain an image recognition model, for example, an intelligent terminal device or a server device. In the present specification, the term “second member device” and the terms “model owner” and “serving-end device” can be used interchangeably.

In an example application example, the second member device 120 can be, for example, a server of a service provider or a service operator, for example, a server device of a third-party payment platform used to provide a face-scanning payment service. Each first member device can be, for example, a client device that performs service interaction with a user, for example, a face-scanning payment device deployed at a checkout counter.

In the present specification, each first member device 110 and the second member device 120 can be any appropriate electronic devices with a calculation capability. The electronic device includes but is not limited to a personal computer, a server computer, a workstation, a desktop computer, a laptop computer, a notebook computer, a mobile electronic device, a smartphone, a tablet computer, a cellular phone, a personal digital assistant (PDA), a handheld apparatus, a message transceiver device, a wearable electronic device, a consumer electronic device, etc.

The first member devices 110-1 to 110-n and the second member device 120 each can have an image recognition model training apparatus. The image recognition model training apparatus in each of the first member devices 110-1 to 110-n and the second member device 120 can perform network communication through a network to exchange data, so as to perform a model training process for an image recognition model in coordination.

As shown in FIG. 1, when image recognition model training is performed, the second member device 120 delivers an image recognition model W to each of the first member devices 110-1 to 110-n. After receiving the image recognition model W, each of the first member devices 110-1 to 110-n locally trains the image recognition model W by using their respective local training sample image data, and provides a local model training result, for example, gradient information Gᵢ^{t} or model parameter information Wᵢ^{t}, of the image recognition model W to the second member device 120. The second member device 120 updates the image recognition model W by using the model training results received from the first member devices. For example, the second member device 120 aggregates the model training results received from the first member devices, and updates the image recognition model W based on an aggregation result. Then, the second member device 120 delivers an updated image recognition model W′ to each of the first member devices 110-1 to 110-n again. This is iteratively performed until a model training end condition is satisfied, thereby ending image recognition model training.

In some implementations, each time the first member device 110 completes local image recognition model training, the first member device 110 provides the model training result to the second member device 120. In some implementations, the first member device 110 provides the model training result to the second member device 120 only when the first member device 110 completes local image recognition model training and a predetermined threshold (for example, a second predetermined threshold) is satisfied. For example, examples of the predetermined threshold can include but are not limited to: a round interval, e.g., a difference in a number of iterations, between a current number of training rounds of the image recognition model and a number of training rounds of the image recognition model when a model training result was previously sent to the second member device 120 reaches a threshold number of rounds (that is, a second threshold number of rounds). For example, the first member device 110 can provide, only every t rounds, the model training result in a current training round to the second member device 120 for image recognition model updating. However, in another training round, the first member device 110 only locally completes model updating of the image recognition model, and completes a next round of model training by using an updated image recognition model.

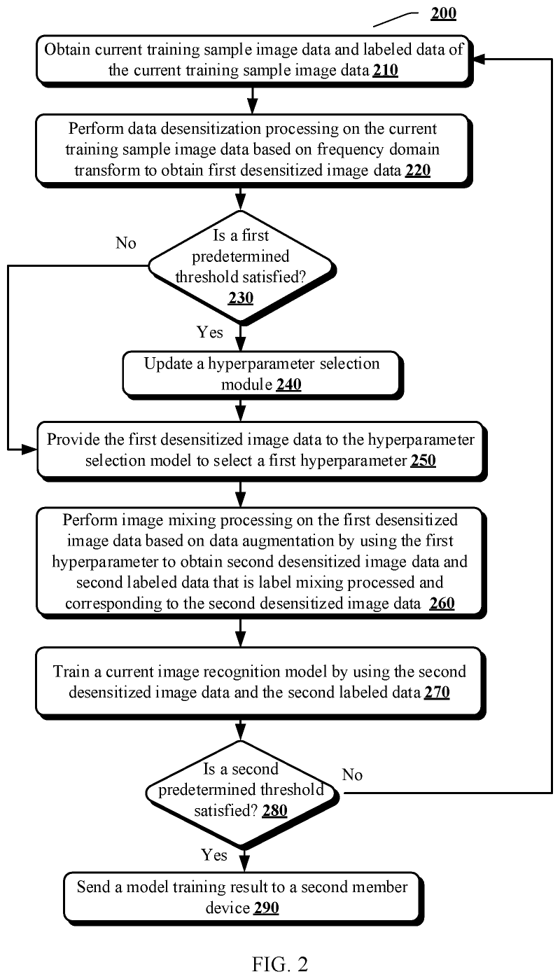

FIG. 2 is an example flowchart illustrating an image recognition model training method 200 performed on a first member device side according to an implementation of the present specification.

It should be noted that an image recognition model training process performed on the first member device side is an iterative process until a training end condition is satisfied. For example, examples of the training end condition include but are not limited to: a number of training rounds has been reached, or an image recognition result satisfies a predetermined requirement, for example, an image recognition rate reaches a predetermined value, or an image recognition difference falls within a predetermined range. The image recognition model training process shown in FIG. 2 is a round of training process of the iterative process.

For example, as shown in FIG. 2, in 210, current training sample image data and label data of the current training sample image data are obtained. When an image recognition model is a facial recognition model, the training sample image data can include, for example, face image data, and a label of the training sample image data can be identity information corresponding to a face in an image, for example, a name of a person. The label of the training sample image data can be manually added, or can be added in another manner. This is not limited in this implementation. In some implementations, the training sample image data and the label of the training sample image data can be read from a database or obtained by invoking a data interface.

The training sample image data can be original face image data, or can be image data obtained after face detection or face alignment is performed on the original face image data. The original face image data can be unprocessed image data that is directly collected by an image collection device, for example, a camera. Face detection detects a location of a face in an image, and to-be-processed image data can be an image obtained after clipping is performed based on the location of the face in the image, for example, an extra part other than the face is clipped from the image. Face alignment corrects an angle of a face in an image. A face in an original face image is possibly tilted at an angle, and face alignment can be used to straighten the face in the image, so as to facilitate subsequent image recognition processing, etc.

In some implementations, a processing device can obtain the training sample image data by using a camera of a terminal device, or can read the training sample image data from a database or a storage device, or obtain the training sample image data by invoking a data interface.

It should be noted that, a program/code for obtaining the training sample image data can run in a trusted execution environment deployed in the processing device, and a security feature of the trusted execution environment can be used to prevent image data obtained by the processing device from being stolen. In addition, the method and/or the process disclosed in this implementation of the present specification can also be executed in the trusted execution environment, so as to ensure that an entire process from an acquisition source of the training sample image data to processing of the training sample image data is secure and trusted, thereby improving security of privacy protection for the training sample image data.

In 220, data desensitization processing is performed on the current training sample image data based on frequency domain transform to obtain first desensitized image data of the current training sample image data.

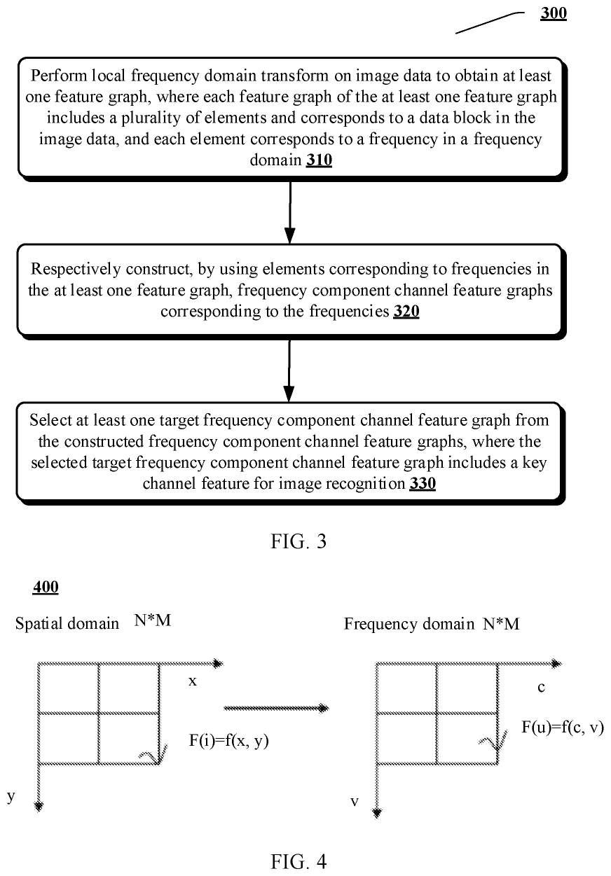

FIG. 3 is an example flowchart illustrating a data desensitization processing process 300 based on frequency domain transform according to an implementation of the present specification.

As shown in FIG. 3, in 310, local frequency domain transform processing is performed on the current training sample image data to obtain at least one feature graph, where each feature graph of the at least one feature graph includes a plurality of elements and corresponds to a data block in the image data, and each element corresponds to a frequency in a frequency domain.

The feature graph refers to a plurality of subgraphs extracted from to-be-processed image data by using a certain image processing means, and each subgraph includes some features of the to-be-processed image data. A size of the obtained feature graph can be the same as a size of the training sample image data, for example, pixels are in a one-to-one correspondence; or can be different from the size of the training sample image data.

In some implementations, examples of local frequency domain transform processing can include but are not limited to local discrete cosine transform, local wavelet transform, or local discrete Fourier transform.

FIG. 4 is an example schematic diagram illustrating transform of image data from a spatial domain to a frequency domain according to an implementation of the present specification. In FIG. 4, the spatial domain is represented by a coordinate system (x, y), the frequency domain is represented by a coordinate system (c, v), and N*M represents a size of an image, for example, the size is 2*2 in FIG. 4. A number of feature points in the spatial domain can be the same as a number of feature points in the frequency domain after transform. One square block in the spatial domain represents a pixel location, and one square block in the frequency domain represents a frequency location.

In some implementations, the following discrete cosine transform formula (1) can be used to perform discrete cosine transform on to-be-transformed gray image data.

$$F ( u , v ) = \frac{1}{4} c ( u ) c ( v ) {\sum }_{x = 0}^{N - 1} {\sum }_{y = 0}^{M - 1} f ( x , y ) cos [ \frac{( x + 0.5 ) π}{N} u ] cos [ \frac{( y + 0.5 ) π}{N} v ] , \qquad ( 1 )$$

F(u, v) is a value of the feature point (that is, each frequency location) in the frequency domain after transform, f(x, y) is a pixel value in to-be-transformed image data (the gray image data), (u, v) is coordinates of the feature point in the frequency domain after transform, (x, y) is coordinates of the to-be-transformed image data in the spatial domain, N is a number of rows of pixels or feature points in the to-be-transformed image data, and M is a number of columns of the pixels or the feature points in the to-be-transformed image data. For example, when a size of the to-be-processed image data is 8*8, and N=M=8.

c(u) can be represented by using the following formula (2):

$$c ( u ) = \{ \begin{matrix}\sqrt{\frac{1}{\sqrt{2}}} , & if u = 0 \\ 1 , & u \neq 0\end{matrix} , \qquad ( 2 )$$

where c(u)=c(v).

Local frequency domain transform processing can be performed on the image data to obtain a plurality of transform results, that is, a plurality of feature graphs. During local frequency domain transform processing, an image block (a local image block) smaller than to-be-transformed image data can be selected, for example, a size of the to-be-transformed image data is 256×256, and a size of the selected image block is 8×8. Then, mobile sampling is performed on the to-be-transformed image data based on the size of the selected image block by using a specific step (for example, 8), and discrete cosine transform is performed, based on formula (1) and formula (2), local data (that is, a data block with a size of 8×8) of the to-be-transformed image data obtained in each time of sampling. Therefore, a plurality of transform results are obtained, and each transform result can have a size of 8×8. A smaller moving step of the image block used during the discrete cosine transform indicates a larger number of features included in the obtained transform result, which can help improve accuracy of subsequent image data processing.

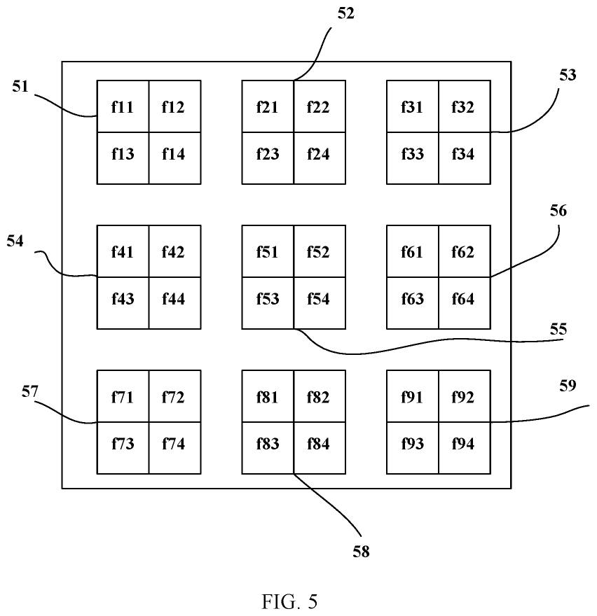

FIG. 5 is an example schematic diagram illustrating a local frequency domain transform process according to an implementation of the present specification. In the example in FIG. 5, a size of to-be-transformed image data is 6×6, a size of a selected local image block is 2×2, mobile sampling is performed on the to-be-transformed image data by using a step 2, and frequency domain transform, for example, discrete cosine transform, is performed on a sampled local image block. Therefore, nine transform results, that is, nine feature graphs, 51, 52, 53, 54, 55, 56, 57, 58, and 59, are obtained. Values at frequency locations in each transform result are respectively represented by fi1, fi2, fi3, and fi4, where i represents an i^{th} transform result, and fij represents a value at a j^{th} frequency location in the i^{th} transform result. It can be learned from the figure that each transform result has four corresponding frequency locations.

In 320, frequency component channel feature graphs corresponding to frequencies are respectively constructed by using elements corresponding to the frequencies in the at least one feature graph. For example, elements or values at same frequency locations in the transform results are combined to obtain a frequency component channel feature graph, to obtain a plurality of frequency component channel feature graphs corresponding to different frequency locations in the transform result. It is not difficult to understand that a number of frequency component channel feature graphs is consistent with a number of pixels of an image block used for sampling in a transform process.

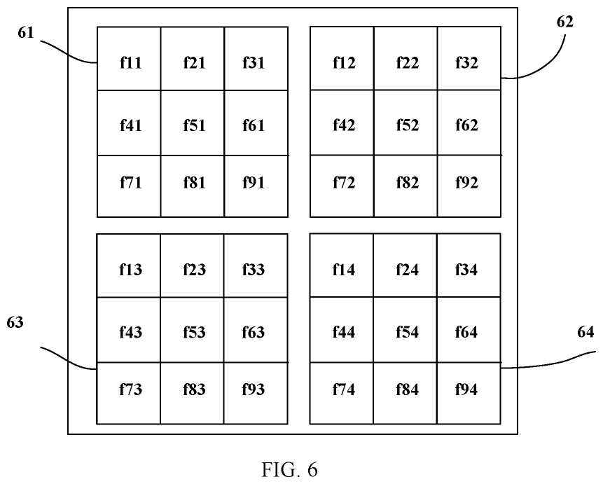

FIG. 6 is an example schematic diagram illustrating a frequency component channel feature graph according to an implementation of the present specification. Frequency component channel feature graphs shown in FIG. 6 are frequency component channel feature graphs corresponding to the transform results in FIG. 5.

As shown in FIG. 6, based on the transform results in FIG. 5, four frequency component channel feature graphs, e.g., a number of pixels of an image block used for sampling is 4, can be obtained, and each frequency component channel feature graph includes nine elements. A frequency component channel feature graph 61 corresponds to a first frequency location fi1, a frequency component channel feature graph 62 corresponds to a second frequency location fi2, a frequency component channel feature graph 63 corresponds to a third frequency location fi3, and a frequency component channel feature graph 64 corresponds to a fourth frequency location fi4.

After the frequency component channel feature graphs are constructed in the above, in 330, at least one target frequency component channel feature graph is selected from the constructed frequency component channel feature graphs, and the selected target frequency component channel feature graph includes a key channel feature for image recognition.

In some implementations, at least one target frequency component channel feature graph can be selected from the constructed frequency component channel feature graphs based on channel importance or based on a predetermined selection rule.

In some implementations, a processing device can input a plurality of transform results to a trained SEnet network, and the SEnet network gives channel importance (for example, a score positively correlated with the importance) of each feature graph. Herein, the channel importance refers to channel importance relative to image recognition. The SEnet network can be obtained through training together with an image recognition model (that is, the SEnet network and the image recognition model are used as a whole). For example, the SEnet network is added to the image recognition model, and a parameter of the SEnet network is adjusted in a process of training the image recognition model, to obtain the SEnet network used to determine channel importance of a feature graph.

In some implementations, the predetermined selection rule can be choosing to reserve some feature graphs of a predetermined proportion that include a large amount of feature information. For example, in a plurality of feature graphs that are obtained through the discrete cosine transform and recombination, some low-frequency feature graphs of a predetermined proportion can be reserved, and some high-frequency feature graphs are discarded. For example, low-frequency feature graphs of a proportion of 50%, 60%, or 70% can be reserved, and the remaining part of high-frequency feature graphs can be discarded. For example, the low-frequency feature graphs 61, 62, and 63 shown in FIG. 6 are reserved, and the high-frequency feature graph 64 is discarded. In the transform result obtained after the discrete cosine transform, a value at a frequency location in an upper left part corresponds to a low-frequency component, and a value at a frequency location in a lower right part corresponds to a high frequency. For example, in the transform result 51 in FIG. 5, f11 corresponds to low-frequency data, and f14 corresponds to high-frequency data. Referring to the above formula (1). When (u, v) is (0, 0),

$$cos [ \frac{( x + 0 \text{.5} ) π}{N} u ] cos [ \frac{( y + 0 \text{.5} ) π}{N} v ] = 1 ,$$

where F(0, 0) includes no alternating-current component, and can be considered as a direct current. Therefore, a frequency corresponding to a value in an upper left corner of the transform result is the lowest. As a coordinate location moves to a lower right corner, F(u, v) includes an alternating- current component, and a frequency increases. Therefore, a frequency corresponding to a value in a lower right corner of the transform result is the highest.

In the example in FIG. 3, the selected at least one target frequency component channel feature graph is used as the first desensitized image data of the training sample image data. In this manner, the first desensitized image data is image data obtained after desensitization processing is performed on the plurality of feature graphs, and can include one or more frequency component channel feature graphs obtained after the desensitization processing. The desensitized image data is different from the to-be-processed image data. Because the desensitized image data is a feature graph, original face information of image data cannot be directly obtained from the desensitized image data.

In the example in FIG. 3, a desensitization processing method includes reconstructing a frequency component channel feature graph for a feature graph and selects a feature graph from frequency component channel feature graphs. In an implementation, in addition to the above operations, the desensitization processing method can further include shuffling processing, normalization processing, channel mixing processing, or any combination thereof.

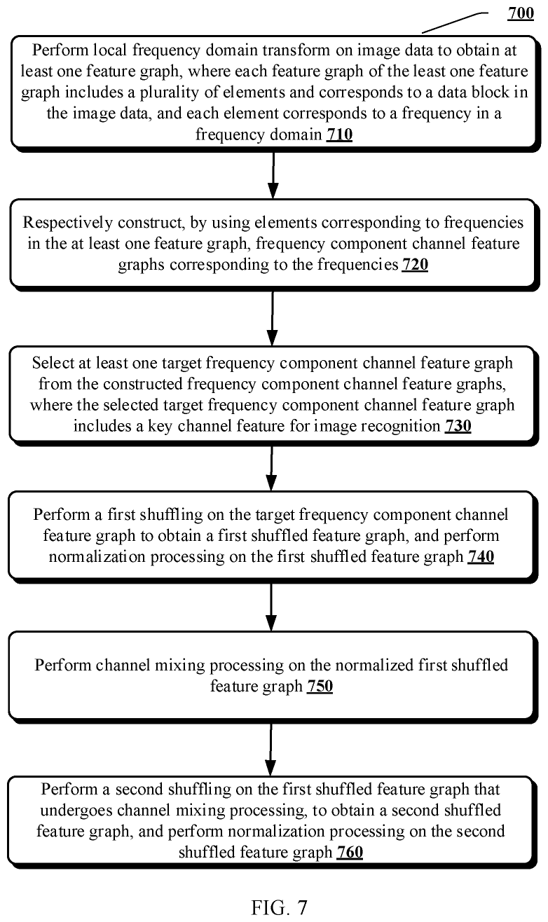

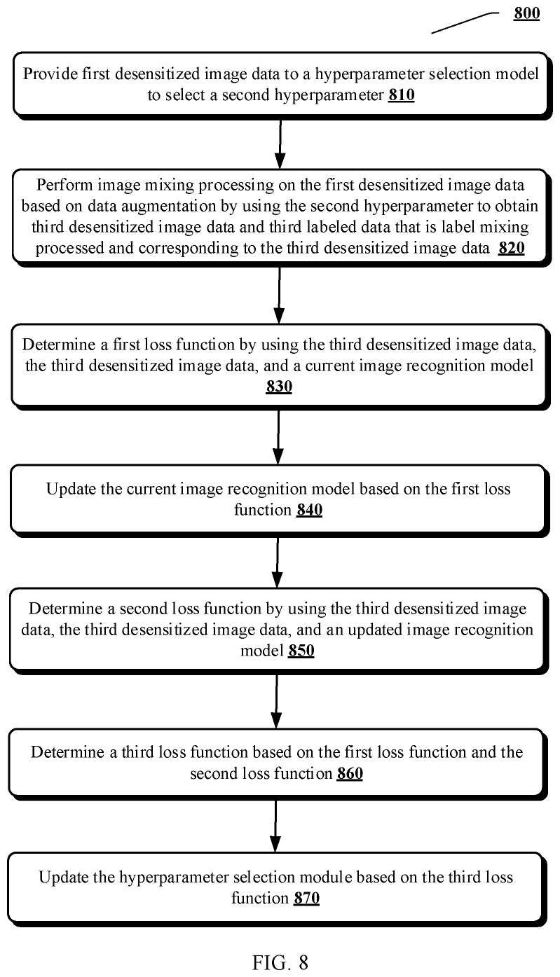

FIG. 7 is an example flowchart illustrating a data desensitization processing process 700 based on frequency domain transform according to an implementation of the present specification. The implementation shown in FIG. 7 is a modified implementation for the implementation shown in FIG. 3. Steps 710 to 730 in FIG. 7 may be exactly the same as steps 310 to 330 in FIG. 3. For simplicity of description, same contents of FIG. 7 are not described herein, but only differences over FIG. 3 are described.

As shown in FIG. 7, after the target frequency component channel feature graph is selected in 730, the selected target frequency component channel feature graph is not used as the first desensitized image data, but operations of 740 to 760 continue to be performed, to obtain more secure first desensitized image data.

For example, after the at least one target frequency component channel feature graph is selected from the constructed frequency component channel feature graphs, in 740, a first shuffling (shuffle) processing is performed on the selected target frequency component channel feature graph to obtain first shuffled feature graph. In addition, normalization processing is performed on the first shuffled feature graph. In some implementations, data obtained after normalization processing is performed on the first shuffled feature graph can be directly used as the first desensitized image data. In some implementations, subsequent processing may be performed on the data obtained after normalization processing is performed on the first shuffled feature graph, to obtain the first desensitized image data.

In some implementations, the first shuffling processing may perform order randomization on the selected target frequency component channel feature graph. Order randomization disrupts a ranking order of a plurality of feature graphs. For example, a plurality of selected target frequency component channel feature graphs are 61, 62, and 63 in FIG. 6, and a ranking order obtained after order randomization can be 63, 61, and 62.

In some implementations, normalization parameters are parameters used when normalization processing is performed on a plurality of target frequency component channel feature graphs. During normalization processing, a normalization coefficient of each frequency component channel feature graph can be determined based on the frequency component channel feature graph, so that a normalization parameter used when normalization processing is performed on each frequency component channel feature graph is related to only the frequency component channel feature graph, but not related to another frequency component channel feature graph. In this way, a difficulty in inversely deriving voice data can be increased. For example, it is assumed that a frequency component channel feature graph is inversely derived. However, because parameters used when normalization is performed on frequency component channel feature graphs are different, another frequency component channel feature graph cannot be inversely derived by using a normalization parameter of the frequency component channel diagram that is inversely derived. The above normalization processing can also be referred to as self-normalization processing.

In some implementations, the normalization parameter can be an average or a variance of all values in the frequency component channel feature graph, or can be a maximum value or a minimum value in all the values in the frequency component channel feature graph. Normalization processing may remove a value of each element in the frequency component channel feature graph by using the normalization parameter, and replacing an original value with a quotient obtained through division, to obtain a frequency component channel feature graph obtained after the normalization processing.

Through the first shuffling processing and corresponding normalization processing, original data in the selected target frequency component channel feature graph cannot be obtained, so that data privacy security of the selected target frequency component channel feature graph can be protected.

In 750, channel mixing processing is performed on the normalized first shuffled feature graph.

Mixing processing may calculate two or more feature graphs in a plurality of frequency component channel feature graphs in a predetermined calculation manner. For example, values of corresponding elements in two or more frequency component channel feature graphs can be calculated, and calculated values are used as values of corresponding elements in a mixed frequency component channel feature graph. In this way, two or more frequency component channel feature graphs can be mixed into one frequency component channel feature graph. The predetermined calculation manner can be calculating an average, a sum, a difference, etc.

In some implementations, channel mixing may mix two adjacent frequency component channel feature graphs. It should be noted that, when feature graphs are combined, a combination rule should be the same for different frequency component channel feature graphs. For example, starting from the first frequency component channel feature graph, a current frequency component channel feature graph is combined with a next frequency component channel feature graph adjacent to the current frequency component channel feature graph, to be specific, the first frequency component channel feature graph is combined with the second frequency component channel feature graph, and the second frequency component channel feature graph is combined with the third frequency component channel feature graph. In this manner, for M frequency component channel feature graphs, (M−1) frequency component channel feature graphs can be obtained, to reduce dimensions.

In some implementations, when two adjacent frequency component channel feature graphs are mixed, a number of selected target frequency component channel feature graphs can be set to a feature dimension of the training sample image data plus one. According to this processing manner, a feature dimension of the obtained desensitized image data can be the same as a feature dimension of the training sample image data, so that a model architecture of an image recognition model does not need to be modified.

After channel mixing is performed, values of elements in the frequency component channel feature graph obtained after channel mixing change compared with values of the frequency component channel feature graph before channel mixing. As a result, a relative relationship between values of elements in the original frequency component channel feature graph can be destroyed, so that difficulty of inversely deducing original image data based on the frequency component channel feature graph can be further increased.

After the above channel mixing is performed, in 760, a second shuffling processing is performed on the first shuffled feature graph obtained after the channel mixing processing, to obtain a second shuffled feature graph. In addition, normalization processing is performed on the second shuffled feature graph. For the second shuffling processing and normalization processing of the second shuffling processing, references can be made to the description of 750. Details are omitted herein for simplicity. In some implementations, data obtained after the normalization processing has been performed on the second shuffled feature graph can be directly used as the first desensitized image data. In some implementations, subsequent processing is performed on the data obtained after the normalization processing has been performed on the second shuffled feature graph, to obtain the first desensitized image data.

Through the second shuffling processing and corresponding normalization processing, original data in the frequency component channel feature graph obtained after channel mixing cannot be obtained, so that data privacy security of the frequency component channel feature graph obtained after channel mixing can be protected. It should be noted that in some implementations, the first shuffling processing can be performed by using pseudorandom shuffling processing, and the second shuffling processing can be performed by using fully random shuffling processing.

In the data desensitization processing process shown in FIG. 7, because two times of shuffling and normalization processing are involved, difficulty of brute-force cracking can be greatly increased. For example, local cosine transform is performed on first feature data based on a local image block of 8*8, and 64 frequency component channel feature graphs can be constructed. In addition, after shuffling processing is performed on the frequency component channel feature graphs, placement of a frequency component of each small block (one frequency component channel feature graph corresponds to one frequency component) in a transform result is random, and a size of random brute-force cracking space is 64!, where “!” represents a factorial operation. Even if channel selection is performed on the frequency component channel feature graphs based on channel importance to determine, for example, 36 main feature graphs, the brute-force cracking space is 36!. In the desensitization process, two randomization processes are used, so that the size of the brute-force cracking space is 36!*36!, whose value is greater than 256 bits of key cracking space of an AES encryption algorithm, which makes it difficult to inversely derive original voice data through brute-force cracking. In addition, a normalization parameter depends on only a corresponding frequency component channel feature graph, and normalization parameters of different frequency component channel feature graphs are different. Therefore, it is more difficult to infer a normalization parameter of each frequency component channel feature graph. Moreover, channel mixing processing is further performed on the frequency component channel feature graph, and only a result obtained after channel mixing is reserved. This damages a relative relationship between values of frequency component channel feature graphs, thereby further improving difficulty of data cracking, and improving privacy protection security of voice data.

Referring back to FIG. 2, after the first desensitized image data is obtained in the above, it is determined whether a first predetermined threshold is satisfied in 230. For example, examples of the first predetermined threshold include but are not limited to: a round interval between a current number of training rounds of the image recognition model and a number of training rounds of the image recognition model at a time of a previous update processing of a hyperparameter selection model reaches a first threshold number of rounds, for example, m rounds. For example, model updating processing is performed on the hyperparameter selection model every m rounds.

If the first predetermined threshold is satisfied, a hyperparameter model is updated in 240, and then proceed to 250. If the first predetermined threshold is not satisfied, directly proceed to 250.

FIG. 8 is an example flowchart illustrating a process 800 of updating a hyperparameter selection model according to an implementation of the present specification. In some implementations, for example, examples of the hyperparameter selection model can include but are not limited to a Resnet18 network.

As shown in FIG. 8, in 810, the first desensitized image data is provided to the hyperparameter selection model to select, from a candidate hyperparameter set, a second hyperparameter used to indicate a number of images participating in image mixing processing. Herein, the selected second hyperparameter is used for image mixing processing in a hyperparameter model updating process.

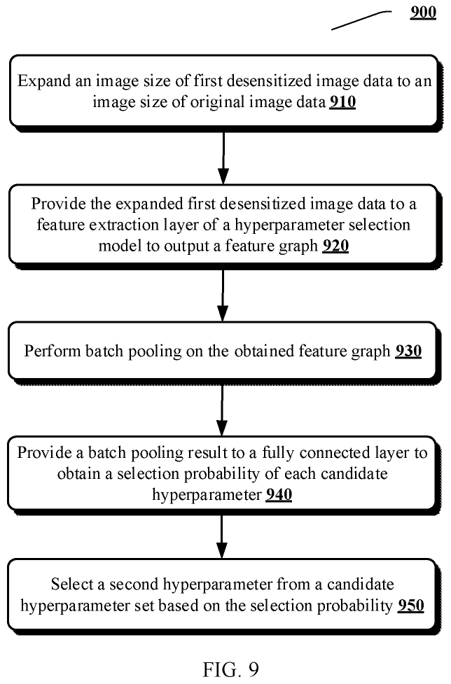

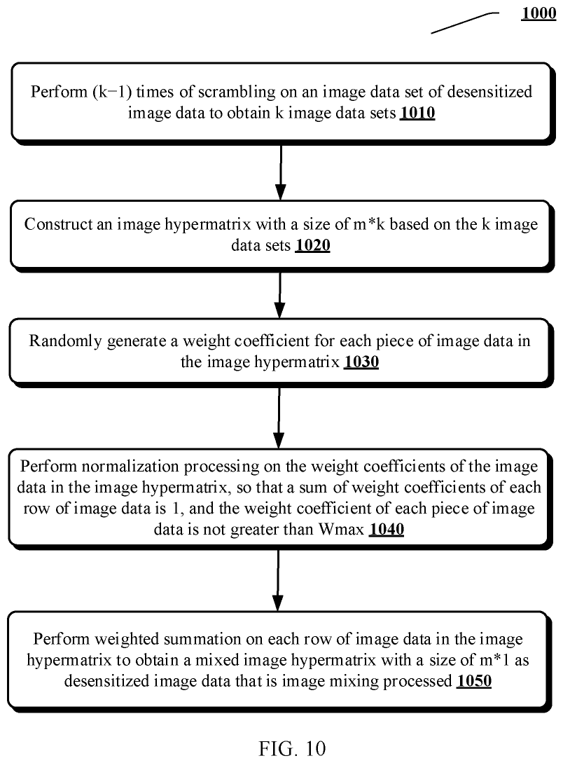

FIG. 9 is an example flowchart illustrating a hyperparameter selection process 900 based on a hyperparameter selection model according to an implementation of the present specification.

As shown in FIG. 9, in 910, an image size of the first desensitized image data is scaled to an original image size of training sample image data. For example, the first desensitized image data can be provided to an adaptation layer of a Resnet18 network, and the adaptation layer performs width and height interpolation processing on the first desensitized image data, to scale the image size of the first desensitized image data to the original image size of the training sample image data. Through the above image scaling processing, the existing Resnet18 network can be applied as the hyperparameter model to the implementations of the present specification without another modification by simply adjusting an input channel size at a first level to a larger number of channels.

In 920, the scaled first desensitized image data is provided to a feature extraction layer of the hyperparameter selection model to extract a feature graph representation of the first desensitized image data. It should be noted that the feature graph representation obtained herein is a feature graph representation of image data of an entire batch size, that is, a feature graph representation of the batch size. For example, a matrix dimension of the obtained feature graph representation is b*c*h*w, where b is the batch size, c is a number of channels, h is a feature graph height dimension, and w is a feature graph width dimension.

In 930, pooling processing is performed on the obtained feature graph representation of the first desensitized image data, so that a dimension b of a number of images in the feature graph representation is processed from a batch size-dimension to one dimension through pooling, so as to obtain a feature graph representation obtained after pooling processing, where a matrix dimension of the feature graph representation is 1*c*h*w.

In 940, a pooling result is provided to a fully connected layer of the hyperparameter selection model to obtain a selection probability of each candidate hyperparameter in the candidate hyperparameter set. Herein, the candidate hyperparameter is a hyperparameter used to indicate a number of images participating in image mixing processing. The candidate hyperparameter set is usually a discrete parameter set, for example, {2, 3, 4, 5, 6}.

In 950, the second hyperparameter is selected based on the selection probability of each candidate hyperparameter.

Referring back to FIG. 8, in 820, image mixing processing is performed on the first desensitized image data based on data augmentation by using the second hyperparameter to obtain third desensitized image data and third label data that is label mixing processed and corresponding to the third desensitized image data.

Mixup data augmentation usually has two hyperparameters. One hyperparameter is a maximum weight coefficient Wₘₐₓ of a mixed image (a sum of all weight coefficients of the mixed image is 1). Generally, the maximum weight coefficient Wₘₐₓ is 0.65 by default. In some implementations, the maximum weight coefficient Wₘₐₓ can be set to 0.55, so that different images can contribute more data to mixing, thereby providing a higher privacy protection capability. The other hyperparameter is a quantity k of images participating in a mixing operation. A larger value of k indicates more mixed information, a stronger privacy protection capability, and a lower recognition rate.

FIG. 10 is an example flowchart illustrating an image mixing processing process 1000 based on Mixup data augmentation according to an implementation of the present specification.

As shown in FIG. 10, in 1010, (k−1) times of scrambling processing are performed on an image data set of the obtained desensitized image data to obtain k image data sets.

In 1020, an image hypermatrix with a size of m*k is constructed based on the obtained k image data sets, where a first column in the constructed image hypermatrix corresponds to an original image data set, the remaining columns each correspond to an image data set obtained after each time of scrambling processing, and m is an amount of subgraph data in the original image data set.

In 1030, a weight coefficient is randomly generated for each piece of image data in the image hypermatrix.

In 1040, the weight coefficients of the image data in the image hypermatrix is normalized, so that a sum of weight coefficients of each row of image data is 1, and the weight coefficient of each piece of image data is not greater than Wₘₐₓ. In other words, after normalization is performed, a maximum weight coefficient of each row of images cannot exceed Wₘₐₓ, for example, 0.55.

In 1050, weighted summation is performed on each row of image data in the image hypermatrix to obtain a mixed image hypermatrix with a size of m*1, where an image in the obtained mixed image hypermatrix is the third desensitized image data obtained after image mixing processing.

In addition, when image mixing processing is performed, label mixing processing is further performed on corresponding label data of each piece of desensitized image data by using a weight coefficient of the desensitized image data, so as to obtain, for each piece of desensitized image data, label data that is label mixing processed.

In some implementations, when label mixing processing is performed, if image data participating in image mixing processing is from a same classification, labels of all the image data participating in image mixing processing remain unchanged. If at least a part of the image data participating in image mixing processing is from different classifications, a non-zero value in the labels of all the image data is adjusted to k non-zero values, and each non-zero value corresponds to a weight coefficient of a piece of subgraph data.

Referring back to FIG. 8, in 830, a first loss function Loss₁ is determined by using the third desensitized image data, the corresponding label data that is label mixing processed, and a current image recognition model.

For example, the third desensitized image data can be provided to the current image recognition model to obtain first predicted label data of the third desensitized image data. Then, the first loss function Loss₁ is determined based on the first predicted label data and the corresponding label data that is label mixing processed.

In the present specification, the image recognition model can be any appropriate machine learning model.

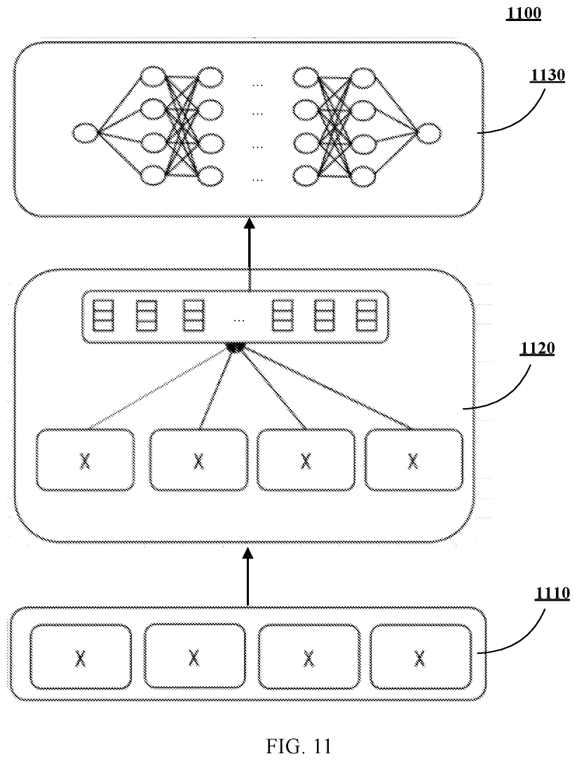

FIG. 11 is an example diagram illustrating a structure of an image recognition model 1100 according to an implementation of the present specification. As shown in FIG. 11, the image recognition model 1100 can include an input layer 1110, a feature extraction layer 1120, and an output layer 1130.

The input layer 1110 can be configured to receive desensitized image data that is image mixing processed obtained after image data processing described with reference to FIG. 2 is performed.

In some implementations, the input layer 1110 can have a plurality of input channels, a number of the plurality of input channels can be the same as a number of feature graphs (for example, frequency component channel feature graphs) in the desensitized image data, and each channel corresponds to one feature graph.

In some implementations, a number of input channels of an initially created image recognition model can be adjusted to make the number of input channels consistent with a number of feature graphs obtained by using the above image processing method.

In some implementations, a number of selected target feature graphs can be set, so that the number of feature graphs in the obtained desensitized image data is consistent with a number of channels of an original image recognition model. Therefore, a model architecture of the original image recognition model can be used without any adjustment.

The feature extraction layer 1120 can be configured to process the input desensitized image data to obtain a feature graph representation (or referred to as a predicted vector) of the desensitized image data.

In some implementations, the feature extraction layer can be a deep neural network, such as a CNN network or an RNN network. The feature extraction layer can process (such as convolution or pooling) each feature graph to obtain a more abstract feature graph representation.

The output layer 1130 can transform the feature graph representation into an identification recognition result of a target object corresponding to the desensitized image data.

The target object can be an organism or an object in an image, or a part of the image, for example, a person, a face, an animal, or a building.

The identification recognition result can be a corresponding identity of the target object in the image, for example, an identity of a person, a category of an animal, and a name of a building.

The output layer 1130 can transform the feature graph representation of the desensitized image data to obtain a predicted value, where the predicted value can indicate identity information of a task in the image, that is, the identification recognition result of the target object.

In some implementations, the output layer 1130 can be a multi-layer sensor, a fully connected layer, etc. This is not limited in this implementation.

In 840, the current image recognition model is updated based on the first loss function. For example, gradient information of each model parameter of the image recognition model can be determined based on the first loss function, and then a parameter updating amount of each model parameter is determined based on the gradient information, and the image recognition model is updated based on the determined parameter updating amount.

In 850, a second loss function Loss₂ is determined by using the third desensitized image data, the corresponding label data that is label mixing processed, and an updated image recognition model.

For example, the third desensitized image data is provided to the updated current image recognition model to obtain second predicted label data of the third desensitized image data, and the second loss function Loss₂ is determined based on the second predicted label data and the corresponding label data that is label mixing processed.

In 860, a third loss function Loss₃ is determined based on the first loss function Loss₁ and the second loss function Loss₂. For example, a formula Loss₃=(a*Loss₁+b*Loss₂)*Proₖ can be used, where a and b are weights corresponding to the first loss function and the second loss function, and Proₖ is a selection probability of the second hyperparameter k.

In 870, a model parameter of the hyperparameter selection model is updated based on the third loss function Loss₃. For example, gradient information of each model parameter of the hyperparameter selection model can be determined based on the third loss function Loss₃, and then a parameter updating amount of each model parameter is determined based on the gradient information, and the hyperparameter selection model is updated based on the determined parameter updating amount.

Referring back to FIG. 2, in 250, the first desensitized image data is provided to the hyperparameter selection model to select, from the candidate hyperparameter set, a first hyperparameter used to indicate a number of images participating in image mixing processing. It should be noted that if the hyperparameter selection model is updated, an updated hyperparameter selection model is used in 250 to select the first hyperparameter. If the hyperparameter selection model is not updated, the original hyperparameter selection model is used in 250 to select the first hyperparameter.

In 260, image mixing processing is performed on the first desensitized image data based on Mixup data augmentation by using the first hyperparameter to obtain second desensitized image data and second label data that is label mixing processed and corresponding to the second desensitized image data.

In 270, the current image recognition model is trained by using the second desensitized image data and the second label data, to obtain a model recognition result of the current image recognition model. The model training result can include, for example, gradient information, a model parameter updating amount, or an updated model parameter.

For example, the second desensitized image data can be provided to the current image recognition model to predict third predicted label data of the second desensitized image data, and a fourth loss function is determined based on the third predicted label data and the obtained label data that is label mixing processed. Then, the model training result of the current image recognition model is determined based on the fourth loss function.

In 280, it is determined whether a second predetermined threshold is met. For example, examples of the second predetermined threshold can include but are not limited to: a round interval between a current number of training rounds of the image recognition model and a number of training rounds of the image recognition model when a previous training result was sent reaches a threshold number of rounds, e.g., a second threshold number of rounds.

If the second predetermined threshold is not satisfied, return to 210 to perform a next iterative training process by using an updated image recognition model. If the second predetermined threshold is satisfied, in 290, the model training result of the current image recognition model is provided to a second member device. In response to receiving model training results from a plurality of first member devices, the second member device updates the image recognition model by using the model training results from the plurality of first member devices, and provides an updated image recognition model to each first member device for a next round of image recognition model training.

It should be noted that the descriptions of the above procedures are merely used as examples for description, and are not intended to limit the applicable scope of the implementations of the present specification. A person skilled in the art can make various amendments and changes to the procedure under guidance of the present specification. However, these amendments and changes still fall within the scope limited by the implementations of the present specification. For example, in other implementations, some of the steps in FIG. 2 can be removed, for example, some or all of the operations in 230, 240, and 280 can be removed.

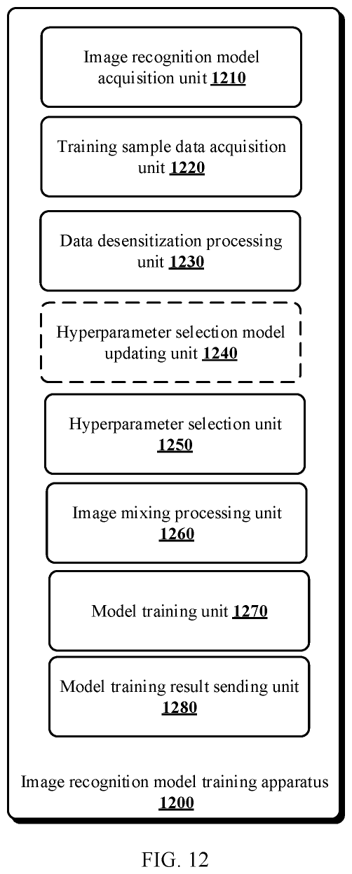

FIG. 12 is an example block diagram illustrating an image recognition model training apparatus 1200 according to an implementation of the present specification. As shown in FIG. 12, the image recognition training apparatus 1200 includes an image recognition model receiving unit 1210, a training sample data acquisition unit 1220, a data desensitization processing unit 1230, a hyperparameter selection model updating unit 1240, a hyperparameter selection unit 1250, an image mixing processing unit 1260, a model training unit 1270, and a model training result sending unit 1280.

The image recognition model receiving unit 1210, the training sample data acquisition unit 1220, the data desensitization processing unit 1230, the hyperparameter selection model updating unit 1240, the hyperparameter selection unit 1250, the image mixing processing unit 1260, the model training unit 1270, and the model training result sending unit 1280 iteratively perform operations until a training end condition is satisfied. For example, examples of the training end condition include but are not limited to: a number of training rounds is reached, or an image recognition result satisfies a predetermined requirement, for example, an image recognition rate reaches a predetermined value, or an image recognition difference falls within a predetermined range.

During each round of model training, the image recognition model receiving unit 1210 is configured to receive a current image recognition model from a second member device configured to maintain an image recognition model. It should be noted that in some implementations, the image recognition model receiving unit 1210 does not receive, in all rounds of model training, the current image recognition model from the second member device configured to maintain an image recognition model. For example, when a first member device sends a model training result of the image recognition model to the second member device every t rounds, the image recognition model receiving unit 1210 receives, only when the second member device receives the model training result and updates the image recognition model based on the received model training result, an updated image recognition model from the second member device configured to maintain an image recognition model, and uses the updated image recognition model as a current image recognition model for a next round of model training.

The training sample data acquisition unit 1220 is configured to obtain current training sample image data and label data of the current training sample image data. For the operation of the training sample data acquisition unit 1220, references can be made to the operation described above with reference to 210 in FIG. 2.

The data desensitization processing unit 1230 is configured to perform data desensitization processing on the current training sample image data based on frequency domain transform to obtain first desensitized image data of the current training sample image data. For the operation of the data desensitization processing unit 1230, references can be made to the operation described above with reference to 220 in FIG. 2.

The hyperparameter selection model updating unit 1240 is configured to update a model parameter of a hyperparameter selection model based on the first desensitized image data. In some implementations, the hyperparameter selection model updating unit 1240 is configured to update the model parameter of the hyperparameter selection model based on the first desensitized image data in response to that a first predetermined threshold is satisfied. For the operation of the hyperparameter selection model updating unit 1240, references can be made to the operation described above with reference to 240 in FIG. 2.

The hyperparameter selection unit 1250 is configured to provide the first desensitized image data to the hyperparameter selection model to select, from a candidate hyperparameter set, a first hyperparameter used to indicate a number of images participating in image mixing processing. For the operation of the hyperparameter selection unit 1250, references can be made to the operation described above with reference to 250 in FIG. 2.

The image mixing processing unit 1260 is configured to perform image mixing processing on the first desensitized image data based on Mixup data augmentation by using the first hyperparameter to obtain second desensitized image data and second label data that is label mixing processed and corresponding to the second desensitized image data. For the operation of the image mixing processing unit 1260, references can be made to the operation described above with reference to 260 in FIG. 2.

The model training unit 1270 is configured to train the current image recognition model by using the second desensitized image data and the second label data. For the operation of the model training unit 1270, references can be made to the operation described above with reference to 270 in FIG. 2.

The model training result sending unit 1280 is configured to send a model training result of the current image recognition model to the second member device, for the second member device to update the current image recognition model by using the model training result. In some implementations, the model training result sending unit 1280 is configured to send the model training result of the current image recognition model to the second member device in response to that a second predetermined threshold is satisfied, for the second member device to update the current image recognition model by using the model training result.

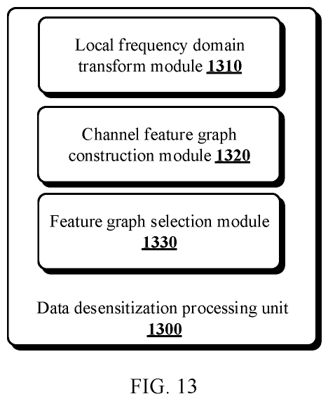

FIG. 13 is an example block diagram illustrating a data desensitization processing unit 1300 according to an implementation of the present specification. As shown in FIG. 13, the data desensitization processing unit 1300 includes a local frequency domain transform module 1310, a channel feature graph construction module 1320, and a feature graph selection module 1330.

The local frequency domain transform module 1310 is configured to perform local frequency domain transform processing on image data to obtain at least one feature graph, where each feature graph of the at least one feature graph includes a plurality of elements and corresponds to a data block in the image data, and each element corresponds to a frequency in a frequency domain. For the operation of the local frequency domain transform module 1310, references can be made to the operation described above with reference to 310 in FIG. 3.

The channel feature graph construction module 1320 is configured to respectively construct, by using elements corresponding to frequencies in the at least one feature graph, frequency component channel feature graphs corresponding to the frequencies. For the operation of the channel feature graph construction module 1320, references can be made to the operation described above with reference to 320 in FIG. 3.

The feature graph selection module 1330 is configured to select at least one target frequency component channel feature graph from the constructed frequency component channel feature graphs to obtain desensitized image data of the image data, where the selected target frequency component channel feature graph includes a key channel feature for image recognition. For the operation of the feature graph selection module 1330, references can be made to the operation described above with reference to 330 in FIG. 3.

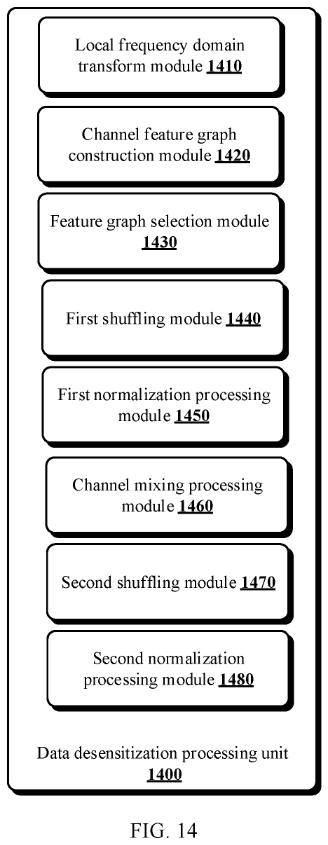

FIG. 14 is an example block diagram illustrating a data desensitization processing unit 1400 according to another implementation of the present specification. As shown in FIG. 14, the data desensitization processing unit 1400 includes a local frequency domain transform module 1410, a channel feature graph construction module 1420, a feature graph selection module 1430, a first shuffling module 1440, a first normalization processing module 1450, a channel mixing processing module 1460, a second shuffling module 1470, and a second normalization processing module 1480.

The local frequency domain transform module 1410 is configured to perform local frequency domain transform processing on image data to obtain at least one feature graph, where each feature graph of the at least one feature graph includes a plurality of elements and corresponds to a data block in the image data, and each element corresponds to a frequency in a frequency domain. For the operation of the local frequency domain transform module 1410, references can be made to the operation described above with reference to 710 in FIG. 7.

The channel feature graph construction module 1420 is configured to respectively construct, by using elements corresponding to frequencies in the at least one feature graph, frequency component channel feature graphs corresponding to the frequencies. For the operation of the channel feature graph construction module 1420, references can be made to the operation described above with reference to 720 in FIG. 7.

The feature graph selection module 1430 is configured to select at least one target frequency component channel feature graph from the constructed frequency component channel feature graphs, where the selected target frequency component channel feature graph includes a key channel feature for image recognition. In some implementations, the feature graph selection module 1430 can select at least one target frequency component channel feature graph from the constructed frequency component channel feature graphs based on channel importance or based on a predetermined selection rule. For the operation of the feature graph selection module 1430, references can be made to the operation described above with reference to 730 in FIG. 7.

The first shuffling module 1440 is configured to perform a first shuffling processing on the target frequency component channel feature graph to obtain a first shuffled feature graph. The first normalization processing module 1450 is configured to perform normalization processing on the first shuffled feature graph. For the operations of the first shuffling module 1440 and the first normalization processing module 1450, references can be made to the operations described above with reference to 740 in FIG. 7.

The channel mixing processing module 1460 is configured to perform channel mixing processing on the first shuffled feature graph that is normalization processed. For the operation of the channel mixing processing module 1460, references can be made to the operation described above with reference to 750 in FIG. 7.

The second shuffling module 1470 is configured to perform a second shuffling processing on the first shuffled feature graph that is channel mixing processed, to obtain a second shuffled feature graph. The second normalization processing module 1480 is configured to perform normalization processing on the second shuffled feature graph. For the operations of the first shuffling module 1470 and the second normalization processing module 1480, references can be made to the operations described above with reference to 760 in FIG. 7.

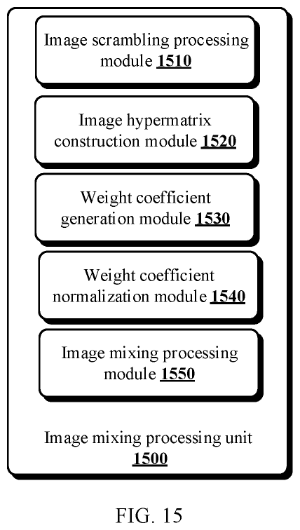

FIG. 15 is an example block diagram illustrating an image mixing processing unit 1500 according to an implementation of the present specification. As shown in FIG. 15, the image mixing processing unit 1500 includes an image scrambling processing module 1510, an image hypermatrix construction module 1520, a weight coefficient generation module 1530, a weight coefficient normalization module 1540, and an image mixing processing module 1550.

The image scrambling processing module 1510 is configured to perform (k−1) times of scrambling processing on an image data set of desensitized image data to obtain k image data sets. For the operation of the image scrambling processing module 1510, references can be made to the operation described above with reference to 1010 in FIG. 10.

The image hypermatrix construction module 1520 is configured to construct an image hypermatrix with a size of m*k based on the obtained k image data sets, where a first column in the constructed image hypermatrix corresponds to an original image data set, and m is an amount of image data in the original image data set. For the operation of the image hypermatrix construction module 1520, references can be made to the operation described above with reference to 1020 in FIG. 10.

The weight coefficient generation module 1530 is configured to randomly generate a weight coefficient for each piece of image data in the image hypermatrix. For the operation of the weight coefficient generation module 1530, references can be made to the operation described above with reference to 1030 in FIG. 10.

The weight coefficient normalization module 1540 is configured to normalize the weight coefficients of the image data in the image hypermatrix, so that a sum of weight coefficients of each row of image data is 1, and a maximum coefficient of each image is not greater than Wₘₐₓ. For the operation of the weight coefficient normalization module 1540, references can be made to the operation described above with reference to 1040 in FIG. 10.

The image mixing processing module 1550 is configured to perform weighted summation on each row of image data in the image hypermatrix to obtain a mixed image hypermatrix with a size of m*1, where an image in the obtained mixed image hypermatrix is second desensitized image data that is data augmentation processed. For the operation of the image mixing processing module 1550, references can be made to the operation described above with reference to 1050 in FIG. 10.

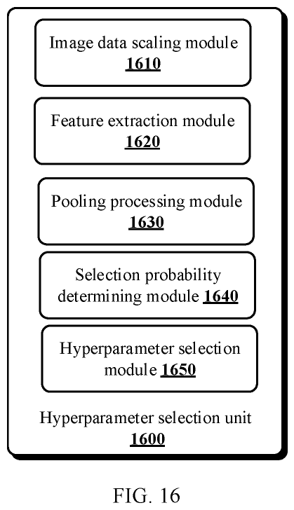

FIG. 16 is an example block diagram illustrating a hyperparameter selection unit 1600 according to an implementation of the present specification. As shown in FIG. 16, the hyperparameter selection unit 1600 includes an image data scaling module 1610, a feature extraction module 1620, a pooling processing module 1630, a selection probability determining module 1640, and a hyperparameter selection module 1650.

The image data scaling module 1610 is configured to scale an image size of first desensitized image data to an original image size of training sample image data. For the operation of the image data scaling module 1610, references can be made to the operation described above with reference to 910 in FIG. 9.

The feature extraction module 1620 is configured to provide the scaled first desensitized image data to a feature extraction layer of a hyperparameter selection model to extract a feature graph representation of the first desensitized image data. For the operation of the feature extraction module 1620, references can be made to the operation described above with reference to 920 in FIG. 9.

The pooling processing module 1630 is configured to perform pooling processing on the obtained feature graph representation of the first desensitized image data, so that a dimension b of a number of images in the feature graph representation is processed from a batch size-dimension to one dimension through pooling. For the operation of the pooling processing module 1630, references can be made to the operation described above with reference to 930 in FIG. 9.

The selection probability determining module 1640 is configured to provide a pooling result to a fully connected layer of the hyperparameter selection model to obtain a selection probability of each candidate hyperparameter in a candidate hyperparameter set. For the operation of the selection probability determining module 1640, references can be made to the operation described above with reference to 940 in FIG. 9.

The hyperparameter selection module 1650 is configured to select a second hyperparameter based on the selection probability of each candidate hyperparameter. For the operation of the hyperparameter selection module 1650, references can be made to the operation described above with reference to 950 in FIG. 9.

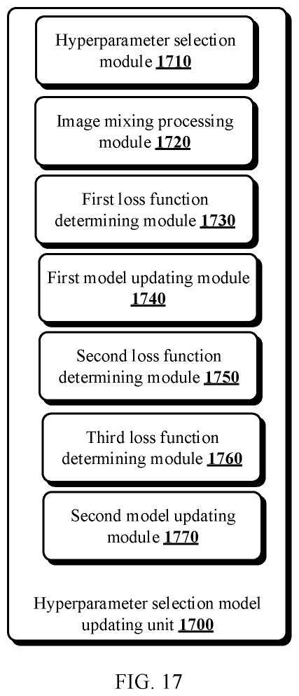

FIG. 17 is an example block diagram illustrating a hyperparameter selection model updating unit 1700 according to an implementation of the present specification. As shown in FIG. 17, the hyperparameter selection model updating unit 1700 includes a hyperparameter selection module 1710, an image mixing processing module 1720, a first loss function determining module 1730, a first model updating module 1740, a second loss function determining module 1750, a third loss function determining module 1760, and a second model updating module 1770.

The hyperparameter selection module 1710 is configured to provide first desensitized image data to a hyperparameter selection model to select, from a candidate hyperparameter set, a second hyperparameter used to indicate a number of images participating in image mixing processing. For the operation of the hyperparameter selection module 1710, references can be made to the operation described above with reference to 810 in FIG. 8.

The image mixing processing module 1720 is configured to perform image mixing processing on the first desensitized image data based on data augmentation by using the second hyperparameter to obtain third desensitized image data and third label data that is label mixing processed and corresponding to the third desensitized image data. For the operation of the image mixing processing module 1720, references can be made to the operation described above with reference to 820 in FIG. 8.

The first loss function determining module 1730 is configured to determine a first loss function by using the third desensitized image data, the corresponding label data that is label mixing processed, and a current image recognition model. For the operation of the first loss function determining module 1730, references can be made to the operation described above with reference to 830 in FIG. 8.

The first model updating module 1740 is configured to update the current image recognition model based on the first loss function. For the operation of the first model updating module 1740, references can be made to the operation described above with reference to 840 in FIG. 8.

The second loss function determining module 1750 is configured to determine a second loss function by using the third desensitized image data, the corresponding label data that is label mixing processed, and an updated image recognition model. For the operation of the second loss function determining module 1750, references can be made to the operation described above with reference to 850 in FIG. 8.

The third loss function determining module 1760 is configured to determine a third loss function based on the first loss function and the second loss function. For the operation of the third loss function determining module 1760, references can be made to the operation described above with reference to 840 in FIG. 8.

The second model updating module 1770 is configured to update a model parameter of the hyperparameter selection model based on the third loss function. For the operation of the second model updating module 1770, references can be made to the operation described above with reference to 850 in FIG. 8.

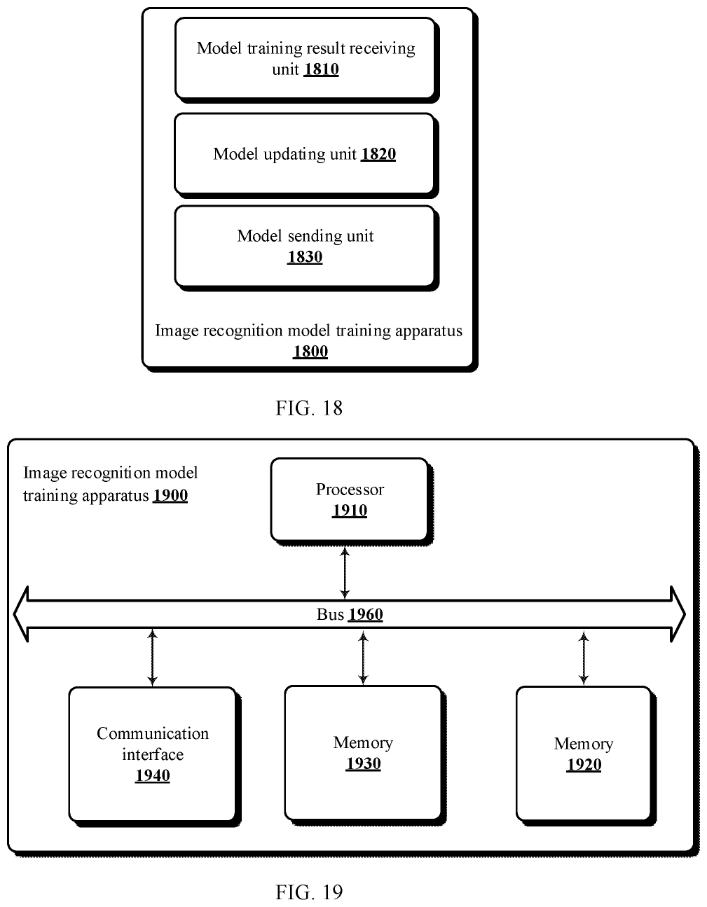

FIG. 18 is an example block diagram illustrating an image recognition model training apparatus 1800 of a second member device according to an implementation of the present specification. As shown in FIG. 18, the image recognition model training apparatus 1800 includes a model training result receiving unit 1810, a model updating unit 1820, and a model sending unit 1830.

The model training result receiving unit 1810 is configured to receive a model training result of an image recognition model from each first member device.

The model updating unit 1820 is configured to update the current image recognition model by using the model training result of the current image recognition model received from each first member device.

The model sending unit 1830 is configured to send an updated image recognition model to each first member device to perform local model training.

Referring to FIG. 1 to FIG. 18, the image recognition model training method and the image recognition model training apparatus according to the implementations of the present specification are described. The above image recognition model training apparatus can be implemented by hardware, or can be implemented by software or a combination of hardware and software.

FIG. 19 is an example schematic diagram illustrating an image recognition model training apparatus 1900 implemented based on a computer system according to an implementation of the present specification. As shown in FIG. 19, the image recognition model training apparatus 1900 can include at least one processor 1910, a data storage device (for example, a non-volatile memory) 1920, a memory 1930, and a communication interface 1940. In addition, the at least one processor 1910, the storage device 1920, the memory 1930, and the communication interface 1940 are connected together by using a bus 1960. The at least one processor 1910 executes at least one computer-readable instruction (that is, the above elements implemented in a software form) stored or encoded in the memory.

In an implementation, computer-executable instructions are stored in the memory, and when the computer-executable instructions are executed, the at least one processor 1910 is enabled to iteratively perform a following model training process until a model training end condition is satisfied, where the model training process includes: obtaining current training sample image data and label data of the current training sample image data; performing data desensitization processing on the current training sample image data based on frequency domain transform to obtain first desensitized image data of the current training sample image data; providing the first desensitized image data to a hyperparameter selection model to select, from a candidate hyperparameter set, a first hyperparameter used to indicate a number of images participating in image mixing processing; performing image mixing processing on the first desensitized image data based on Mixup data augmentation by using the first hyperparameter to obtain second desensitized image data and second label data that is label mixing processed and corresponding to the second desensitized image data; training a current image recognition model by using the second desensitized image data and the second label data; providing a model training result of the current image recognition model to a second member device configured to maintain an image recognition model, for the second member device to update the image recognition model by using model training results from a plurality of first member devices including the first member device; and receiving an updated image recognition model from the second member device, so as to use the updated image recognition model for a next round of image recognition model training.

It should be understood that, when the computer-executable instructions stored in the memory are executed, the at least one processor 1910 performs the above operations and functions described with reference to FIG. 1 to FIG. 18 in the implementations of the present specification.

According to an implementation, a program product such as a machine-readable medium (for example, a non-temporary machine-readable medium) is provided. The machine-readable medium can have instructions (that is, the above elements implemented in a software form). When the instructions are executed by a machine, the machine is enabled to perform the above operations and functions described with reference to FIG. 1 to FIG. 18 in the implementations of the present specification. For example, a system or an apparatus equipped with a readable storage medium can be provided, software program code for implementing a function of any one of the above implementations is stored in the readable storage medium, and a computer or a processor of the system or the apparatus reads and executes instructions stored in the readable storage medium.

In this case, the program code read from the readable medium can implement a function of any one of the above implementations. Therefore, the machine-readable code and the readable storage medium that stores the machine-readable code form a part of the present invention.

Implementations of the readable storage medium include a floppy disk, a hard disk, a magneto-optical disc, an optical disc (such as a CD-ROM, a CD-R, a CD-RW, a DVD-ROM, a DVD-RAM, a DVD-RW, or a DVD-RW), a magnetic tape, a non-volatile storage card, and a ROM. Alternatively, the program code can be downloaded from a server computer or cloud through a communication network.

According to an implementation, a computer program product is provided. The computer program product includes a computer program, and when the computer program is executed by a processor, the processor is enabled to perform the above operations and functions described with reference to FIG. 1 to FIG. 18 in the implementations of the present specification.

A person skilled in the art should understand that various variations and modifications can be made to the implementations disclosed above without departing from the scope of the present invention.

It should be noted that not all steps and units are necessary in the above diagrams of the procedures and the system structures, and some steps or units can be ignored based on an example requirement. An execution order of the steps is not fixed, and can be determined based on a requirement. The apparatus structures described in the above implementations can be physical structures or can be logical structures, that is, some units can be implemented by a same physical entity, or some units can be respectively implemented by a plurality of physical entities, or can be implemented jointly by some components in a plurality of independent devices.

In the above implementations, the hardware units or modules can be implemented in a mechanical manner or an electrical manner. For example, a hardware unit or module or a processor can include a permanent dedicated circuit or logic (for example, a dedicated processor, an FPGA, or an ASIC) to complete a corresponding operation. The hardware unit or the processor can further include programmable logic or a programmable circuit (such as a general-purpose processor or another programmable processor), and can be temporarily disposed by software to complete a corresponding operation. An example implementation (a mechanical manner, a dedicated permanent circuit, or a temporarily disposed circuit) can be determined based on costs and time considerations.

Example implementations described above with reference to the accompanying drawings describe example implementations, but do not represent all implementations that can be implemented or fall within the protection scope of the claims. The term “example” used in the entire specification means “used as an example, an instance, or an illustration”, and does not mean being “preferred” or “advantageous” over other implementations. For the purpose of providing an understanding of the described technologies, the specific implementation includes specific details. However, these technologies can be implemented without these specific details. In some examples, well-known structures and apparatuses are shown in block diagrams to avoid making it difficult to understand the concepts of the described implementations.

The above descriptions of the present disclosure are provided to enable any person of ordinary skill in the art to implement or use the present disclosure. Various modifications made to the present disclosure is obvious to a person of ordinary skill in the art. In addition, the general principle defined in the present specification can also be applied to another variant without departing from the protection scope of the prevent disclosure. Therefore, the present disclosure is not limited to the examples and designs described in the present specification, but is consistent with the widest scope of the principle and the novel feature that conform to the present disclosure.

What is claimed is:

1. An image recognition model training method, the method comprising:
iteratively performing, by a first member device having local training data, a model training process, the model training processing including:
obtaining current training sample image data and label data of the current training sample image data;
performing data desensitization processing on the current training sample image data based on frequency domain transform to obtain first desensitized image data of the current training sample image data;
performing image mixing processing on the first desensitized image data based on Mixup data augmentation by using a first hyperparameter to obtain second desensitized image data and second label data that is label mixing processed and corresponding to the second desensitized image data, the first hyperparameter indicating a number of images participating in the image mixing processing;
training a current image recognition model by using the second desensitized image data and the second label data; and
providing a model training result of the current image recognition model to a second member device configured to maintain an image recognition model, for the second member device to update the image recognition model by using model training results from a plurality of first member devices including the first member device; and
receiving an updated image recognition model from the second member device for a next round of model training.

2. The method according to claim 1, further comprising: in response to that a first determined threshold is satisfied, updating the hyperparameter selection model by using a model updating process, including:
providing the first desensitized image data to a hyperparameter selection model to select, from the candidate hyperparameter set, a second hyperparameter used to indicate the number of images participating in image mixing processing;
performing image mixing processing on the first desensitized image data based on data augmentation by using the second hyperparameter to obtain third desensitized image data and third label data that is label mixing processed and corresponding to the third desensitized image data;
providing the third desensitized image data to the current image recognition model to obtain second predicted label data of the third desensitized image data, and determining a first loss function based on the second predicted label data and the third label data;
updating the current image recognition model based on the first loss function;
providing the third desensitized image data to an updated current image recognition model to obtain third predicted label data of the third desensitized image data, and determining a second loss function based on the third predicted label data and the third label data;
determining a third loss function based on the first loss function and the second loss function; and
updating a model parameter of the hyperparameter selection model based on the third loss function to obtain an updated hyperparameter selection model,
wherein the first hyperparameter is selected using the updated hyperparameter selection model.

3. The method according to claim 2, wherein the first determined threshold comprises:
a round interval between a current number of training rounds of the image recognition model and a number of training rounds at a time of a previous update processing of the hyperparameter selection model reaches a first threshold number of rounds.

4. The method according to claim 1, wherein the providing the model training result of the current image recognition model to the second member device includes:
providing the model training result of the current image recognition model to the second member device in response to that a second determined threshold is satisfied.

5. The method according to claim 4, wherein the second determined threshold comprises:
a round interval between a current number of training rounds of the image recognition model and a number of training rounds of the image recognition model when a previous training result was sent reaches a second threshold number of rounds.

6. The method according to claim 1, wherein the first hyperparameter is k, and a maximum weight coefficient for image mixing is Wₘₐₓ; and
the performing image mixing processing on the first desensitized image data based on data augmentation by using the first hyperparameter includes:
performing (k−1) times of scrambling processing on an image data set of the first desensitized image data to obtain k image data sets;
constructing an image hypermatrix with a size of m*k based on the k image data sets, wherein a first column in the image hypermatrix corresponds to the image data set of the first desensitized image data in an original form before the scrambling processing, and m is an amount of image data in the image data set;
randomly generating a weight coefficient for each piece of image data in the image hypermatrix;
normalizing weight coefficients of the image data in the image hypermatrix, so that a sum of weight coefficients of each row of image data is 1, and the weight coefficient of each piece of image data is not greater than Wₘₐₓ; and
performing weighted summation on each row of image data in the image hypermatrix to obtain a mixed image hypermatrix with a size of m*1, wherein the image data in the mixed image hypermatrix is desensitized image data augmentation processed.

7. The method according to claim 1, wherein the performing data desensitization processing on the current training sample image data based on frequency domain transform includes:
performing local frequency domain transform processing on the current training sample image data to obtain at least one feature graph, wherein each feature graph of the at least one feature graph includes a plurality of elements and corresponds to a data block in the current training sample image data, and each element corresponds to a frequency in a frequency domain;
respectively constructing, by using elements corresponding to frequencies in the at least one feature graph, frequency component channel feature graphs corresponding to the frequencies; and
selecting at least one target frequency component channel feature graph from the frequency component channel feature graphs to obtain desensitized image data of the current training sample image data, wherein the selected target frequency component channel feature graph includes a channel feature for image recognition.

8. The method according to claim 7, further comprising: after the selecting the at least one target frequency component channel feature graph from the frequency component channel feature graphs,
performing a first shuffling processing on the target frequency component channel feature graph to obtain a first shuffled feature graph; and
performing normalization processing on the first shuffled feature graph to obtain the first desensitized image data of the current training sample image data.

9. The method according to claim 8, further comprising: after the performing normalization processing on the first shuffled feature graph,
performing channel mixing processing on the first shuffled feature graph that is normalization processed;
performing a second shuffling processing on the first shuffled feature graph that is channel mixing processed, to obtain a second shuffled feature graph; and
performing normalization processing on the second shuffled feature graph to obtain the first desensitized image data of the current training sample image data.

10. The method according to claim 1, further comprising:
aggregating, by a second member device, model training results of the current image recognition model received from at least two first member devices including the first member device to update the current image recognition model, and sending an updated image recognition model to the at least two first member devices to perform local model training.

11. A computing system, comprising:
at least one processor;
at least one storage device coupled to the at least one processor; and
a computer program stored in the at least one storage device, which when executed by the at least one processor, enable the at least one processor to, individually or collectively, implement acts including:
iteratively performing, by a first member device having local training data, a model training process, the model training processing including:
obtaining current training sample image data and label data of the current training sample image data;
performing data desensitization processing on the current training sample image data based on frequency domain transform to obtain first desensitized image data of the current training sample image data;
performing image mixing processing on the first desensitized image data based on Mixup data augmentation by using a first hyperparameter to obtain second desensitized image data and second label data that is label mixing processed and corresponding to the second desensitized image data, the first hyperparameter indicating a number of images participating in the image mixing processing;
training a current image recognition model by using the second desensitized image data and the second label data; and
providing a model training result of the current image recognition model to a second member device configured to maintain an image recognition model, for the second member device to update the image recognition model by using model training results from a plurality of first member devices including the first member device; and
receiving an updated image recognition model from the second member device for a next round of model training.

12. The computing system according to claim 11, wherein the acts further include: in response to that a first determined threshold is satisfied, updating the hyperparameter selection model by using a model updating process, including:
providing the first desensitized image data to a hyperparameter selection model to select, from the candidate hyperparameter set, a second hyperparameter used to indicate the number of images participating in image mixing processing;
performing image mixing processing on the first desensitized image data based on data augmentation by using the second hyperparameter to obtain third desensitized image data and third label data that is label mixing processed and corresponding to the third desensitized image data;
providing the third desensitized image data to the current image recognition model to obtain second predicted label data of the third desensitized image data, and determining a first loss function based on the second predicted label data and the third label data;
updating the current image recognition model based on the first loss function;
providing the third desensitized image data to an updated current image recognition model to obtain third predicted label data of the third desensitized image data, and determining a second loss function based on the third predicted label data and the third label data;
determining a third loss function based on the first loss function and the second loss function; and
updating a model parameter of the hyperparameter selection model based on the third loss function to obtain an updated hyperparameter selection model,
wherein the first hyperparameter is selected using the updated hyperparameter selection model.

13. The computing system according to claim 11, wherein the providing the model training result of the current image recognition model to the second member device includes:
providing the model training result of the current image recognition model to the second member device in response to that a second determined threshold is satisfied.

14. The computing system according to claim 13, wherein the second determined threshold comprises:
a round interval between a current number of training rounds of the image recognition model and a number of training rounds of the image recognition model when a previous training result was sent reaches a second threshold number of rounds.

15. The computing system according to claim 11, wherein the first hyperparameter is k, and a maximum weight coefficient for image mixing is Wₘₐₓ; and
the performing image mixing processing on the first desensitized image data based on data augmentation by using the first hyperparameter includes:
performing (k−1) times of scrambling processing on an image data set of the first desensitized image data to obtain k image data sets;
constructing an image hypermatrix with a size of m*k based on the k image data sets, wherein a first column in the image hypermatrix corresponds to the image data set of the first desensitized image data in an original form before the scrambling processing, and m is an amount of image data in the image data set;
randomly generating a weight coefficient for each piece of image data in the image hypermatrix;
normalizing weight coefficients of the image data in the image hypermatrix, so that a sum of weight coefficients of each row of image data is 1, and the weight coefficient of each piece of image data is not greater than Wₘₐₓ; and
performing weighted summation on each row of image data in the image hypermatrix to obtain a mixed image hypermatrix with a size of m*1, wherein the image data in the mixed image hypermatrix is desensitized image data augmentation processed.

16. The computing system according to claim 11, wherein the performing data desensitization processing on the current training sample image data based on frequency domain transform includes:
performing local frequency domain transform processing on the current training sample image data to obtain at least one feature graph, wherein each feature graph of the at least one feature graph includes a plurality of elements and corresponds to a data block in the current training sample image data, and each element corresponds to a frequency in a frequency domain;
respectively constructing, by using elements corresponding to frequencies in the at least one feature graph, frequency component channel feature graphs corresponding to the frequencies; and
selecting at least one target frequency component channel feature graph from the frequency component channel feature graphs to obtain desensitized image data of the current training sample image data, wherein the selected target frequency component channel feature graph includes a channel feature for image recognition.

17. The computing system according to claim 16, wherein the acts further include: after the selecting the at least one target frequency component channel feature graph from the frequency component channel feature graphs,
performing a first shuffling processing on the target frequency component channel feature graph to obtain a first shuffled feature graph; and
performing normalization processing on the first shuffled feature graph to obtain the first desensitized image data of the current training sample image data.

18. The computing system according to claim 17, wherein the acts further include: after the performing normalization processing on the first shuffled feature graph,
performing channel mixing processing on the first shuffled feature graph that is normalization processed;
performing a second shuffling processing on the first shuffled feature graph that is channel mixing processed, to obtain a second shuffled feature graph; and
performing normalization processing on the second shuffled feature graph to obtain the first desensitized image data of the current training sample image data.

19. The computing system according to claim 11, wherein the acts further include:
aggregating, by a second member device, model training results of the current image recognition model received from at least two first member devices including the first member device to update the current image recognition model, and sending an updated image recognition model to the at least two first member devices to perform local model training.

20. A computer-readable storage medium, the computer-readable storage medium storing executable instructions, the executable instructions, when executed by one or more processors, enabling the one or more processors to, individually or collectively, perform acts comprising:
iteratively performing, by a first member device having local training data, a model training process, the model training processing including:
obtaining current training sample image data and label data of the current training sample image data;
performing data desensitization processing on the current training sample image data based on frequency domain transform to obtain first desensitized image data of the current training sample image data;
performing image mixing processing on the first desensitized image data based on Mixup data augmentation by using a first hyperparameter to obtain second desensitized image data and second label data that is label mixing processed and corresponding to the second desensitized image data, the first hyperparameter indicating a number of images participating in the image mixing processing;
training a current image recognition model by using the second desensitized image data and the second label data; and
providing a model training result of the current image recognition model to a second member device configured to maintain an image recognition model, for the second member device to update the image recognition model by using model training results from a plurality of first member devices including the first member device; and
receiving an updated image recognition model from the second member device for a next round of model training.
